(19) United States
(12) Patent Application Publication
(10) Pub. No.: US 2026/0032488 A1
(43) Pub. Date: Jan. 29, 2026

(54) UE-TRIGGERED RE-CONFIGURATION FOR APPLICATION-LAYER MEASUREMENTS REPORTING

(71) Applicant: Apple Inc., Cupertino, CA (US)

(72) Inventors: Ping-Heng Kuo, London (GB); Naveen Kumar R Palle Venkata, San Diego, CA (US); Peng Cheng, Beijing (CN); Ralf Rossbach, Munich (DE); Haijing Hu, Los Gatos, CA (US); Fangli Xu, Beijing (CN); Alexander Sirotkin, Hod Hasharon (IS)

(21) Appl. No.: 18/997,069

(22) PCT Filed: Jul. 20, 2023
(86) PCT No.: PCT/US2023/028199

§ 371 Date: Jan. 18, 2025

Related U.S. Application Data
(60) Provisional application No. 63/396,239, filed on Aug. 9, 2022.

(51) Int. Cl. H04W 24/10

(52) U.S. Cl. CPC H04W 24/10

(57) ABSTRACT

Techniques, described herein, include solutions for reconfiguration of Quality of Experience (QoE) reporting triggered by a user equipment (UE). In one aspect, a UE reporting evaluation is performed to evaluate QoE reporting based on UE status or previous QoE measurement result. The UE then transmits a QoE reconfiguration request or notification to a Base Station (BS) indicating QoE measurement reconfiguration preference or decision based on the UE reporting evaluation. Upon receiving a granting response or confirmation from the BS, the UE may pause, resume, suspend, or change QoE reporting accordingly.

### REFERENCE TO RELATED APPLICATIONS

This application claims the benefit of U.S. Provisional Patent Application No. 63/396,239 entitled “UE-TRIGGERED RECONFIGURATION FOR QUALITY OF EXPERIENCE (QOE) MEASUREMENT REPORTING” and U.S. Provisional Patent Application No. 63/396,241 entitled “QUALITY OF EXPERIENCE (QOE) MEASUREMENT REPORTING BASED ON UE EVALUATION”, both filed on Aug. 9, 2022, the contents of which are herein incorporated by reference in their entirety.

### FIELD

This disclosure relates to wireless communication networks including techniques for reporting application layer measurements.

### BACKGROUND

Wireless communication networks may include user equipments (UEs), base stations (BSs), and/or other types of wireless devices capable of communicating with one another. During operation, a UE may perform application layer measurements and report the measurement results to a network for radio resource management, for example. The application layer measurement reporting is also referred as Quality of Experience (QoE) reporting.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a block diagram illustrating a wireless network including a user equipment (UE) and a base station (BS) for UE-triggered QoE measurement reconfiguration in accordance with some aspects of the disclosure.

FIG. 2 is a schematic diagram illustrating signaling between a UE and a BS for UE-triggered QoE measurement reconfiguration in accordance with some aspects of the disclosure.

FIG. 3 is a flow diagram illustrating a method for a UE to trigger QoE measurement reconfiguration in accordance with some aspects of the disclosure.

FIG. 4 is a schematic diagram illustrating signaling between a UE and a BS for UE-triggered QoE measurement reconfiguration in accordance with some additional aspects of the disclosure.

FIG. 5 is a flow diagram illustrating a method for a UE to trigger QoE measurement reconfiguration in accordance with some additional aspects of the disclosure.

FIG. 6 is a schematic diagram illustrating signaling between a UE and a BS for QoE measurement configuration based on UE evaluation in accordance with some aspects of the disclosure.

FIG. 7 is a schematic diagram illustrating signaling between a UE and a BS for QoE measurement configuration based on UE evaluation in accordance with some additional aspects of the disclosure.

FIG. 8 is a block diagram illustrating a device that can be employed in accordance with some aspects of the present disclosure.

FIG. 9 is a block diagram illustrating baseband circuitry that can be employed in accordance with some aspects of the present disclosure.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

A user may experience various services, such as Augmented Reality (AR), Virtual Reality (VR), multicast/broadcast services and audio/video streaming, or the like, through a User Equipment (UE). Quality of Experience (QoE) is a metric used to measure end-to-end performance of such services at the application level from perspective of the user. During operation, the UE may run various applications and perform corresponding QoE measurements. The QoE measurements, which is also be referred to as application layer measurements, convey information related to the user experience of an application. For example, for video streaming, a QoE measurement relating to playout delay may indicate how long a frame has been stalled, or how long the video has been buffering. In some cases, the QoE measurement can be reported to network, for example, for radio resource management.

The QoE reporting falls into two categories. “Regular” QoE measurements (which may also be referred to as “container based” QoE measurements), and “radio access network (RAN) visible” QoE measurements. Container based QoE measurements are included in a container that may be transmitted to a base station (BS), and then forwarded by the BS to a management entity. The content of the container may not be visible to the BS. Container based QoE measurements may be used by Operations, Administration, and Maintenance (OAM) for purposes such as analytics. RAN visible QoE measurements, on the other hand, are reported to the BS and include contents visible to the BS and may be utilized by the BS to improve radio resource management.

The BS may pause or change QoE reporting in order to address situations such as RAN overload, reduce energy consumption and achieve more efficient operation. For example, the BS can use an RRC message including a pause indication to temporarily stop the UE from sending QoE reports associated with one or multiple QoE measurement configurations. When the UE receives the QoE measurement reporting pause indication, the UE temporarily stores QoE reports in an Access Stratum (AS) layer. When the UE receives the QoE measurement reporting resume indication, the UE sends the stored QoE reports to the BS.

On the other hand, the UE may intend to pause or change QoE reporting patterns from a UE perspective based on UE status or previous QoE measurement results. For example, the UE may prefer to pause or reduce QoE reporting if the UE has a low battery or high mobility. As another example, the UE may reject QoE reporting if it has a strict privacy setting. Accordingly, the present disclosure relates to techniques for a UE to trigger reconfiguration of QoE reporting. In some aspects, the UE that is configured to report a QoE measurement may perform a UE reporting evaluation such as evaluating its own status and/or previous QoE measurement results, and then pause, resume, suspend, or change the QoE reporting based on the UE reporting evaluation. In one aspect, a result of the UE reporting evaluation is indicated by a QoE reconfiguration request sent by the UE, indicating a preference of the UE on the reconfiguration of QoE reporting. The QoE reconfiguration request is transmitted to a BS, and the BS may respond with the QoE measurement reconfiguration. In another alternative aspect, the UE determines the pausing, resuming, or changing of the QoE reporting on its own based on the reporting evaluation without waiting for a response from the BS. In this case, the UE transmits a QoE reconfiguration notification to the BS.

Either the QoE reconfiguration request or the QoE reconfiguration notification may contain information related to QoE measurement reconfigurations and may be transmitted by various signaling as explained in more detailed examples below. By implementing UE-triggered mechanisms for QoE measurement reconfiguration, the UE may provide suggestion or even determination based on the evaluation of its own status and/or previous measurements. Thus, UE performance may be further optimized such as reducing power consumption or channel resource occupation when the UE is in a low power or low-quality connection status.

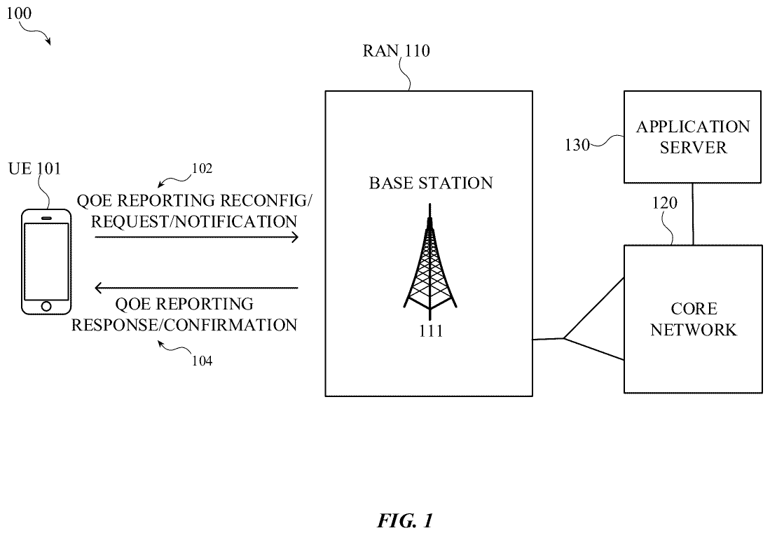

FIG. 1 is a block diagram illustrating a wireless network 100 including a UE 101 and a BS 111 for UE-triggered QoE measurement reconfiguration in accordance with some aspects. The features discussed throughout the disclosure associated with other figures may be incorporated in the wireless network 100 when applicable. Also, the following description is provided for an example system that operates in conjunction with the 5G or NR system standards as provided by 3GPP technical specifications. However, the example aspects are not limited in this regard and the described aspects may apply to other networks that benefit from the principles described herein, such as future 3GPP systems (e.g., Sixth Generation (6G)) systems, IEEE 802.16 protocols (e.g., WMAN, WiMAX, etc.), or the like.

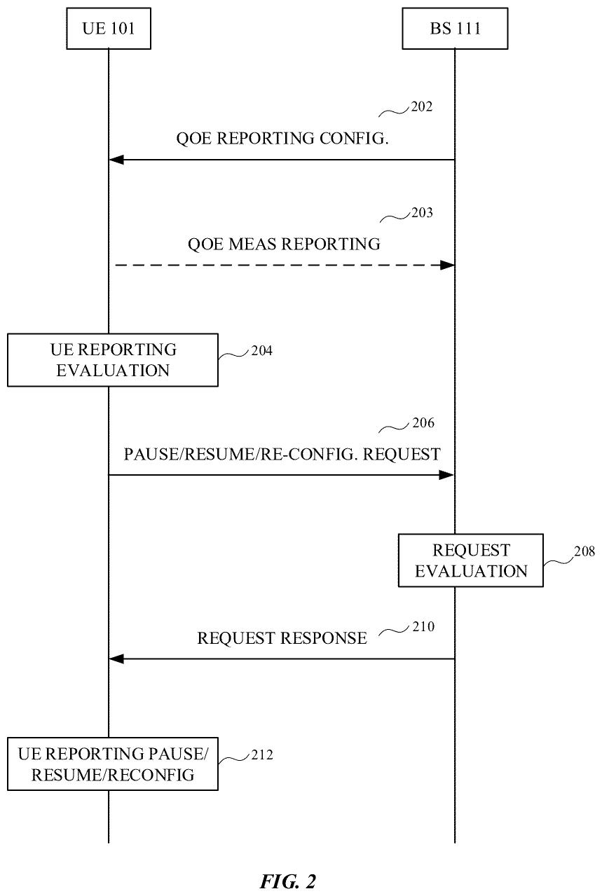

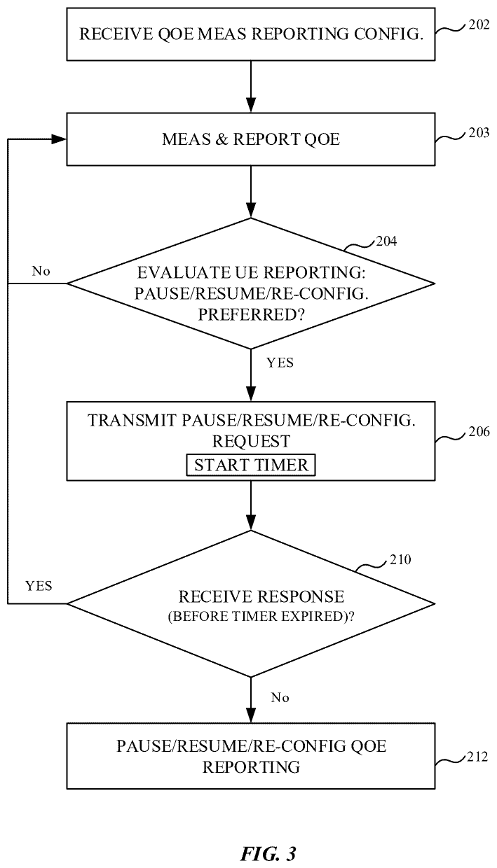

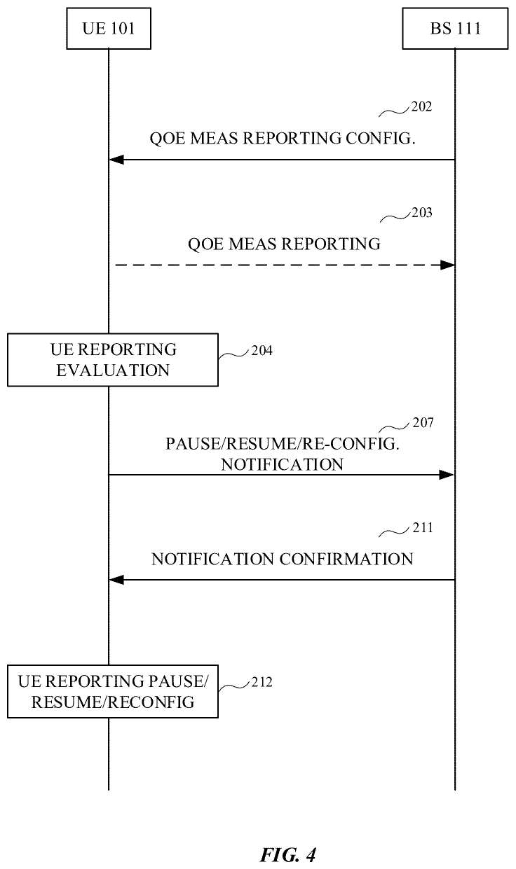

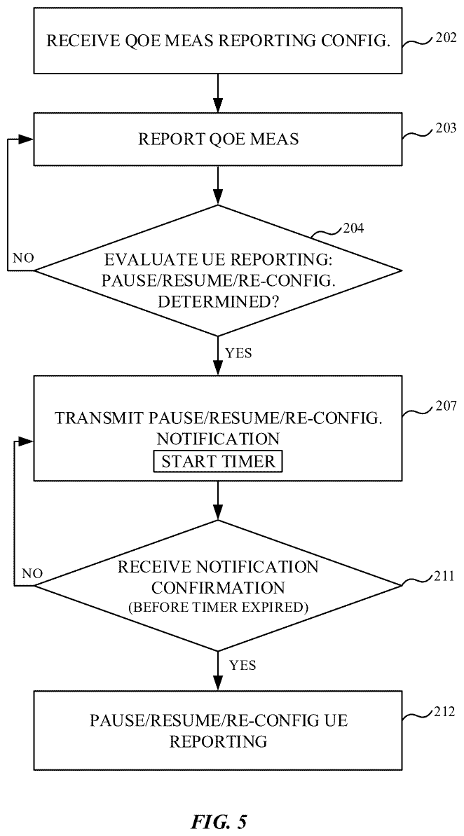

As shown by FIG. 1, the UE 101 and the BS 111 may utilize connections (or channels) comprising a physical communications interface/layer for downlink and uplink respectively. In some aspects, the UE 101, based on its own status or previous QoE measurement results, may utilize uplink connection to transmit QoE measurement reconfiguration request or notification at act 102. The BS 111, in response to the received QoE measurement reconfiguration request or notification, may utilize downlink connection to transmit a QoE reconfiguration response or confirmation at act 104. In one aspect, as further explained associated with FIGS. 2-3, the QoE measurement reconfiguration request indicates a preference of the UE 101 to pause, resume, suspend, or change QoE reporting, and the QoE reconfiguration response from the BS 111 may include an approval or rejection of the QoE measurement reconfiguration request. Alternatively, as further explained associated with FIGS. 4-5, the QoE measurement reconfiguration notification may notify the BS 111 a decision of the UE 101 to pause, resume, suspend, or change the QoE reporting, and the BS 111 may or may not send an acknowledgement to confirm the reception of the decision. In some aspects, the UE 101 may perform a UE reporting evaluation according to the UE status or previous QoE measurement results to determine the QoE measurement reconfiguration.

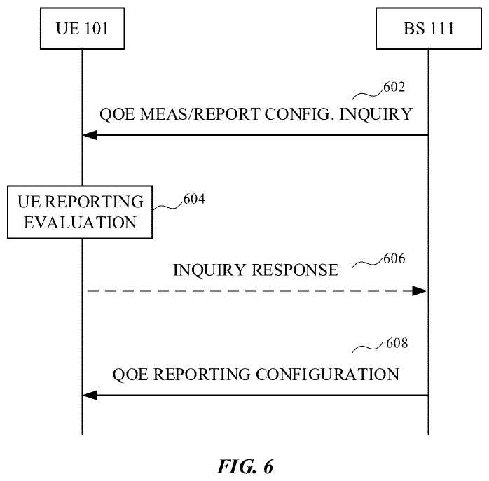

In some aspects, as further explained associated with FIG. 6, the BS 111 may send a QoE measurement/reporting configuration inquiry to the UE 101 prior to configuring the UE 101 for QoE measurement/reporting. The UE 101 may perform a UE reporting evaluation to determine whether to accept the QoE measurement/reporting configuration proposed by the BS 111, and then send a configuration inquiry response to the BS 111 according to the UE reporting evaluation.

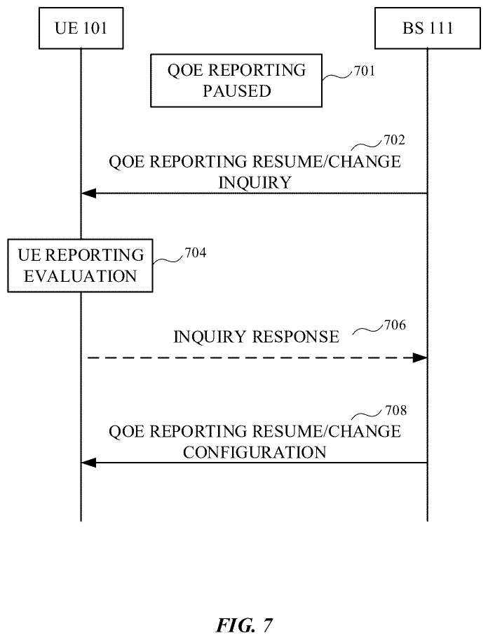

In some additional aspects, as further explained associated with FIG. 7, after the QoE reporting is paused or changed, the BS 111 may send a QoE reporting inquiry to the UE 101 after a period of time or triggered by certain condition. In response to the QoE reporting inquiry, the UE 101 may perform a UE reporting evaluation to determine whether to resume or change QoE reporting and may send a reporting inquiry response to the BS 111 indicating such a decision.

The UE 101 is illustrated as a smartphone (e.g., a handheld touchscreen mobile computing device connectable to one or more cellular networks), but can comprise any mobile or non-mobile computing device, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

The UE 101 can be configured to connect, for example, communicatively couple, with a Radio Access Network (RAN) 110. The RAN 110 may comprise one or more BSs 111. In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN” or the like can refer to a RAN 110 that operates in an LTE or 4G system. According to various aspects, the RAN 110 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells. The BS 111 can be an E-UTRAN Node B (Evolved Node B, eNodeB, or eNB), next generation Node B (gNodeB or gNB) or other base station or TRP (Transmit/Receive Point) in a wireless communications network.

The connections between the UE 101 and the BS 111 are illustrated as using an air interface to enable communicative coupling, and can be consistent with cellular communications protocols, such as a GSM protocol, a CDMA network protocol, a PTT protocol, a POC protocol, a UMTS protocol, a 3GPP LTE protocol, a 5G protocol, a NR protocol, and/or any of the other communications protocols discussed herein.

The RAN 110 is shown to be communicatively coupled to a core network (CN) 120. The CN 120 may comprise a plurality of network elements configured to offer various data and telecommunications services to customers/subscribers (e.g., users of the UE 101) who are connected to the CN 120 via the RAN 110. The components of the CN 120 may be implemented in one physical node or separate physical nodes including components to read and execute instructions from a machine-readable or computer-readable medium (e.g., a non-transitory machine-readable storage medium). In some aspects, NFV may be utilized to virtualize any or all of the above-described network node functions via executable instructions stored in one or more computer-readable storage mediums (described in further detail below). A logical instantiation of the CN 120 may be referred to as a network slice, and a logical instantiation of a portion of the CN 120 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

An application server 130 can be an element offering applications associated with the QoE measurements performed by the UE 101. The application server 130 may use IP bearer resources with the CN 120 via an Internet Protocol (IP) interface. The application server 130 can also be configured to support one or more communication services (e.g., VoIP sessions, PTT sessions, group communication sessions, social networking services, etc.) for the UE 101 via the CN 120. The application server 130 can signal the CN 120 to indicate a new service flow and select an appropriate QoS and charging parameters with the appropriate traffic flow template (TFT) and QoS class of identifier (QCI), which commences the QoS and charging as specified by the application server 130.

FIG. 2 illustrates a schematic diagram illustrating signaling between a UE 101 and a BS 111 for UE-triggered QoE measurement reconfiguration in accordance with some aspects of the disclosure. In one aspect, the schematic diagram may be understood as presented along a time line from top to bottom, but various acts could also happen in a different timing order. As specified with more details below, in some aspects, the UE 101 and the BS 111 may exchange preference information and network configuration information to perform pause, resume, suspend, and reconfiguration of the UE-triggered QoE reporting. In some aspects, the signaling and method described associated with FIG. 2 may include further details or additional or alternative features of FIG. 1 and may incorporate some or all features disclosed associated with FIG. 1. In addition, various features shown and described in FIG. 2 may not each be deemed essential or necessary and may be optionally combined in different ways to present different aspects of the disclosure when applicable. These principles applies to other figures throughout the disclosure as well.

At act 202, in some aspects, QoE measurement collection and reporting may be (pre) configured for the UE 101. As an example, the BS 111 may transmit network configuration through an initial random access procedure or an RRC procedure to the UE 101 to configure the UE 101 for measurement collection and reporting duration, periodicity, or other conditions and specifications of QoE measurement collection and reporting. For example, the QoE measurement configuration may specify one or more service type, reporting type, reporting periodicity, whether the UE shall transmit indications when sessions in the application layer start and stop, whether segmentation of QoE reporting is allowed, and number of QoE reports over a period of time. The QoE measurement configuration may be transmitted from the BS 111 to the UE 101 in an RRC message during the RRC connected state. The QoE measurement configuration may also be referred as “application layer measurement configuration” or AppLayerMeasConfig as specified in 3GPP specification.

At act 203, in some aspects, the UE 101 may report the measurement results to the BS 111 according to the QoE measurement (pre) configuration. The UE 101 may also perform QoE measurements based on the QoE measurement (pre) configuration.

At act 204, in some aspects, the UE 101 may be configured to perform QoE reporting evaluation. The QoE reporting evaluation may be used to decide if the QoE reporting is preferred by the UE 101. In some aspects, the QoE reporting evaluation may be based on UE status or UE feedback. Status parameters of the UE 101 for the QoE reporting evaluation may include, for example, battery level of the UE 101, mobility level of the UE 101, or memory usage of the UE 101, buffer status of at least one radio bearer, channel quality, or application user setting (e.g. user privacy setting). For example, the UE 101 may disfavor the QoE reporting, if one or more conditions exist that restrict the QoE reporting. Such conditions may include a low battery, a high mobility, a high memory usage, a larger buffer size or a congested buffer, a bad channel quality, a strict privacy setting, or any combination of the above. On the other hand, the UE 101 may allow the QoE reporting if none of the conditions exists.

In some additional aspects, the QoE reporting evaluation at act 204 may be based on UE feedback including previous QoE measurement results. For example, if a QoE measurement result satisfies a threshold value, which indicates a satisfying QoE, the UE 101 may decide to not transmit a QoE report to the BS 111 in order to save resources.

At act 206, in some aspects, the UE 101 may transmit a QoE reconfiguration request to the BS 111. The UE 101 may transmit the QoE reconfiguration request to suggest QoE reporting change according to the QoE reporting evaluation. For example, the QoE reconfiguration request may indicate a preference of the UE 101 on pausing the QoE reporting if the QoE reporting evaluation determines QoE reporting as disfavored. Alternatively or additionally, the QoE reconfiguration request may indicate a preference of the UE 101 on resuming the QoE reporting if the QoE reporting evaluation determines QoE reporting as needed or favored. The QoE reconfiguration request may also indicate a preference of the UE 101 on reporting configuration in idle or inactive state. The QoE reconfiguration request may also indicate a UE preference to configure the QoE reporting in idle or inactive state, in which case the configuration may be transmitted by RRC signaling, for example, in an RRC release message or an RRC reconfiguration message.

The UE 101 may transmit the QoE reconfiguration request to the BS 111 in several ways. In one aspect, the QoE reconfiguration request may include a QoE measurement report or transmitted together with a QoE measurement report. In one aspect, the QoE reconfiguration request may be included and sent in a container. The container may be a transparent container of the application layer, a container carrying the QoE measurement report, or a container dedicated to configurations for QoE measurements and reporting. In another aspect, the QoE reconfiguration request is transmitted in an RRC message independent of the QoE reporting.

In some aspects, the QoE reconfiguration request may be transmitted as part of the UE Assistance Information (UAI) message as defined in 3GPP specifications (Clause 5.7.4 of TS 38.331), for example. In some alternative aspects, the QoE reconfiguration request may be transmitted by an MAC Control Element (MAC-CE). In some further alternative aspects, the QoE reconfiguration request may be transmitted by a Layer 1 physical layer signaling. In some further alternative aspects, the QoE reconfiguration request may be transmitted in an inactive or idle state. The UE 101 may transmit a QoE reconfiguration request message in the inactive or idle state via Small Data Transmission (SDT) mechanism as defined in 3GPP specifications, for example.

In some aspects, the QoE reconfiguration request comprises information related to one or more parameters of QoE measurement reconfiguration preferred by the UE 101, such as one or more service type, reporting type, reporting periodicity, whether the UE shall transmit indications when sessions in the application layer start and stop, whether segmentation of QoE reporting is allowed, and number of QoE reports over a period of time, or the like. The service type may be a service type of an application, for example, AR/VR, multicast/broadcast services and audio/video streaming, etc. The reporting type may include regular QoEs or RAN-visible QoEs, for example. The QoE reporting occurrence pattern may comprise a reporting periodicity or triggering condition, a reporting duration, a number of QoE reports over a period of time, or the like. The QoE reconfiguration request may further comprise reasoning information indicating a reason why the UE 101 prefers the requested QoE reconfiguration. For example, the reasoning information may include UE status information such as power level, mobility level, memory usage, buffer status of at least one radio bearer, channel quality, or application user setting. The reasoning information may also include previous QoE measurement results.

In one aspect, the QoE reconfiguration request is dedicated to one or more specific QoE measurement configurations. The QoE reconfiguration request may specify one or more QoE configuration identities from a set of QoE configuration identities. The QoE configuration identities may also be referred as QoE configuration IDs, or QoE References, or MeasConfigAppLayerld. Each of the set of QoE configuration identities represents parameters of QoE measurement configuration as indicated above. In one aspect, some of the QoE measurement configuration parameters are included in the QoE reconfiguration request, but may not be included individually in each of the set of QoE configuration identities.

At act 208, in some aspects, the BS 111 may perform an evaluation of the received QoE reconfiguration request. For example, the BS 111 may extract the preference information indicated by the UE 101 and request a change of QoE measurement collection (QMC) configuration to at least one entity in a core network (e.g. the CN 120 in FIG. 1) or to an OAM. Additionally or alternatively, the BS 111 may directly forward the QoE reconfiguration request to the OAM or the at least one entity in the core network. The OAM or the at least one entity in the core network may determine if a new configuration is needed. The OAM or the at least one entity in the core network may then respond the determination back to the BS 111.

At act 210, in some aspects, the BS 111 may respond to the received QoE reconfiguration request with a reconfiguration request response. The reconfiguration request response may indicate rejection or approval of the QoE reconfiguration request. The performance of the QoE measurements or the reporting of the QoE measurement results may be paused, resumed, suspended, changed, or otherwise re-configured based on the reconfiguration request response when such a response is expected by the UE 101. For example, the BS 111 may indicate whether the UE 101 can pause, resume, suspend, change, or otherwise re-configure the QoE reporting. In one aspect, the reconfiguration request response may reuse the QoE pause/resume indication in RRCReconfiguration message.

In some alternative aspects, the grant of the QoE reconfiguration request is presumed, and the reconfiguration request response may be transmitted only when the requested reconfiguration is disapproved. For example, a timer may be used by the UE 101 to determine QoE measurement or reporting reconfiguration. For example, the timer can be started when the UE 101 sends the QoE reconfiguration request, and the timer may stop when the reconfiguration request response from the BS 111 is received. Otherwise, if no response is received from the BS 111 before the timer expires, the UE may assume the QoE reconfiguration request is granted (or rejected as an alternative). The UE 101 may then apply (or not apply if the rejection is associated with the timer expiry) its preferred QoE reporting settings.

At act 212, in some aspects, the UE 101 performs the reconfigured QoE reporting, such as pausing, resuming, or changing a previous QoE reporting.

FIG. 3 is a flow diagram illustrating a logic flow of a method for a UE to trigger QoE measurement reconfiguration in accordance with some aspects of the disclosure. In some aspects, the UE, which may be the UE 101 presented associated with FIG. 1 and FIG. 2 for example, may receive a QoE measurement configuration as shown by act 202 and may perform QoE measurement and reporting accordingly as shown by act 203.

In some aspects, the UE may evaluate if QoE measurement reconfiguration is preferred as shown by act 204. The UE may perform QoE reporting evaluation based on UE status or UE feedback. UE status parameters to determine the QoE reporting evaluation may include, for example, battery level of the UE, mobility level of the UE, or memory usage of the UE, buffer status of at least one radio bearer, channel quality, or application user settings such as a user privacy setting. The UE feedback may include, for example, previous QoE measurement results.

If QoE measurement reconfiguration is determined as not preferred, the UE may continue to perform QoE measurement and reporting according to the QoE measurement configuration as shown by act 203. If QoE measurement reconfiguration is determined as preferred, in some aspects, the UE may transmit a QoE reconfiguration request to the BS 111 as shown by act 206. The QoE reconfiguration request may suggest to pause, change or resume the QoE reporting. For example, the QoE reconfiguration request may indicate a preference of the UE on pausing the QoE reporting if the UE determines QoE reporting as disfavored or unnecessary. The QoE reconfiguration request may indicate a preference of the UE on resuming the QoE reporting if the UE determines QoE reporting as needed or favored. The QoE reconfiguration request may also indicate a preference of the UE on reporting configuration in idle or inactive state.

In some aspects, the UE waits to receive a reconfiguration request response from a BS as a reconfiguration indication as shown by act 210. The reconfiguration request response may indicate rejection or approval of the QoE reconfiguration request. In some aspects, the reconfiguration request response may reconfigure the QoE reporting such that the UE pause, resume, suspend, or change the QoE reporting. In some alternative aspects, the QoE reconfiguration request is presumably granted by the BS, and the reconfiguration request response may be received only when the QoE requested reconfiguration is disapproved by the BS.

In some aspects, a timer may start for the UE when transmitting the QoE reconfiguration request, and the timer may stop when the UE receives the reconfiguration request response. If the reconfiguration request response is not received before the timer expires, the UE may assume the QoE reconfiguration request is granted, and then pause, resume or change QoE reporting based on the UE indicated preference of the QoE measurement reconfiguration as shown by act 212. If the reconfiguration request response is received prior to the timer expiry and indicates that the QoE reconfiguration request is rejected, the UE may continue to perform QoE measurement and reporting according to a previous QoE measurement configuration as shown by act 203.

FIG. 4 illustrates a schematic diagram illustrating signaling between a UE 101 and a BS 111 for UE-triggered QoE measurement reconfiguration in accordance with some aspects of the disclosure. In one aspect, the schematic diagram may be understood as presented along a time line from top to bottom, but various acts could also happen in a different timing order. As specified with more details below, in some aspects, the UE 101 and the BS 111 may exchange capability information and network configuration information to perform pause, resume, suspend, and reconfiguration of UE-triggered QoE reporting. In some aspects, the signaling and method described associated with FIG. 4 may include further details or additional or alternative features of FIG. 1 and FIG. 2 and may incorporate some or all features disclosed associated with FIG. 1 and FIG. 2. In some aspects, acts with the same numerals (e.g., acts 202, 203, 204, 212) may perform similar functions, and thus the description is not repeated here for simplicity. In some aspects, after the UE 101 performs the QoE reporting evaluation at act 204, the UE 101 may transmit QoE measurement reconfiguration notification at act 207. The BS 111, in response to the received QoE measurement reconfiguration notification, may transmit a notification confirmation to acknowledge the reception of the decision at act 211.

At act 207, in some aspects, the UE 101 may transmit the QoE reconfiguration notification to indicate QoE reporting change according to the QoE reporting evaluation. For example, the QoE reconfiguration notification may indicate a determination of the UE 101 on pausing the QoE reporting if the QoE reporting evaluation determines QoE reporting as disfavored or unnecessary. Alternatively or additionally, the QoE reconfiguration notification may indicate a determination of the UE 101 on resuming the QoE reporting if the QoE reporting evaluation determines QoE reporting as needed or favored. The QoE reconfiguration notification may also indicate a determination of the UE 101 on reporting configuration in idle or inactive state, in which case the pre-configuration may be transmitted, for example, in an RRC release message or an RRC reconfiguration message.

The UE 101 may transmit the QoE reconfiguration notification to the BS 111 similarly as described above for the QoE reconfiguration request. In one aspect, the QoE reconfiguration notification may include a QoE measurement report or transmitted together with a QoE measurement report. In another aspect, the QoE reconfiguration notification is transmitted in an RRC message independent of QoE reporting. The QoE reconfiguration notification may be part of the UAI message. In some alternative aspects, the QoE reconfiguration notification may be transmitted by an MAC-CE. In some further alternative aspects, the QoE reconfiguration notification may be transmitted by a Layer 1 physical layer signaling.

In some aspects, the QoE reconfiguration notification comprises information related to one or more parameters of QoE measurement reconfiguration determined by the UE 101, one or more service type, reporting type, reporting periodicity, whether the UE shall transmit indications when sessions in the application layer start and stop, whether segmentation of QoE reporting is allowed, and number of QoE reports over a period of time, or the like. The service type may be a service type of an application, for example, AR/VR, multicast/broadcast services and audio/video streaming, etc. The reporting type may include regular QoEs or RAN-visible QoEs, for example. The QoE reporting occurrence pattern may comprise a reporting periodicity or triggering condition, a reporting duration, a number of QoE reports over a period of time, or the like. The QoE reconfiguration notification may further comprise reasoning information for the QoE reconfiguration notification. For example, the reasoning information may include UE status information such as power level, mobility level, memory usage, buffer status of at least one radio bearer, channel quality, or application user setting. The reasoning information may also include previous QoE measurement results.

In one aspect, the QoE reconfiguration notification is dedicated to one or more specific QoE measurement configurations. For example, the QoE reconfiguration notification may indicate whether the decision is for reporting regular QoE, RAN-visible QoE, or the both. The QoE reconfiguration notification may specify one or more QoE configuration identities from a set of QoE configuration identities. Each of the set of QoE configuration identities represents parameters of QoE measurement configuration as described above, such as service type, reporting type (e.g., regular QoE, RAN-visible QoE, or both), periodicity, duration, etc.

At act 211, in some aspects, the BS 111 may respond to the received QoE reconfiguration notification with a notification confirmation. The notification confirmation may indicate a reception of the QoE reconfiguration notification. At act 212, in some aspects, the UE 101 perform the reconfigured QoE reporting, such as pause, resume, suspend, or change a previous QoE reporting.

FIG. 5 is a flow diagram illustrating a logic flow of a method for a UE to trigger QoE measurement reconfiguration in accordance with some aspects of the disclosure. In some aspects, the UE, which may be the UE 101 presented associated with FIG. 1 and FIG. 4 for example. The UE may receive a QoE measurement configuration as shown by act 202 and may perform QoE measurement and reporting accordingly as shown by act 203.

In some aspects, the UE may evaluate if QoE measurement reconfiguration is needed as shown by act 204. The UE may perform QoE reporting evaluation based on UE status or UE feedback. UE status parameters to determine the QoE reporting evaluation may include, for example, battery level of the UE, mobility level of the UE, or memory usage of the UE, buffer status of at least one radio bearer, channel quality, or application user settings such as a user privacy setting. The UE feedback may include, for example, previous QoE measurement results.

If QoE measurement reconfiguration is determined as not needed, the UE may continue to perform QoE measurement and report according to the QoE measurement configuration as shown by act 203. If QoE measurement reconfiguration is determined as needed, in some aspects, the UE may transmit a QoE reconfiguration notification to a BS as shown by act 207. In some aspects, the BS, which may be the BS 111 presented associated with FIG. 1 and FIG. 4 for example. The QoE reconfiguration notification may indicate to the BS that the UE plans to pause, resume, suspend, or change the QoE reporting. For example, the QoE reconfiguration notification may indicate to pause the QoE reporting if the UE determines QoE reporting as disfavored or unnecessary. The QoE reconfiguration notification may indicate to resume the QoE reporting if the UE determines QoE reporting as needed or favored.

In some aspects, the UE may waits to receive a notification confirmation as shown by act 211 prior to executing the QoE reconfiguration, such as pausing, resuming or changing QoE reporting as shown by act 212. The UE may resend the QoE reconfiguration notification as shown by act 207 if the notification confirmation is not received within a pre-determined time. In some aspects, a timer may start for the UE when transmitting the QoE reconfiguration notification, and the timer may stop when the UE receives the notification confirmation. If the notification confirmation is not received when the timer expires, the UE may retransmit the QoE reconfiguration notification as shown by act 207. If the notification confirmation is received before the timer expires, the UE may pause, resume or change QoE reporting as shown by act 212.

FIG. 6 is a schematic diagram illustrating signaling between a UE 101 and a BS 111 for QoE measurement reconfiguration based on UE evaluation in accordance with some additional aspects of the disclosure. Prior to configure or reconfigure QoE measurements or reporting, the BS 111 may transmit QoE configuration inquiry to the UE 101, inquiring preference or capability of the UE 101 to perform such QoE measurement or reporting. Then the BS 111 may configure the UE 101 based on the feedback received from the UE. In one aspect, the schematic diagram may be understood as presented along a time line from top to bottom, but various acts could also happen in a different timing order. In some aspects, some or all features disclosed with reference to FIGS. 1-5 may be incorporated into or combined with features disclosed with reference to FIG. 6 when applicable. For example, acts 602-608 described below may be incorporated before or after the UE transmits the QoE measurement reconfiguration request or notification, as shown by act 206 or act 207 associated with FIGS. 2-5. Alternatively, the acts 602-608 described below may be independent from aspects disclosed above associated with FIGS. 2-5.

For example, at act 602, the BS 111 may transmit QoE configuration inquiry to the UE 101. The QoE configuration inquiry may be transmitted prior to configuring or reconfiguring QoE reporting. In one aspect, the QoE configuration inquiry is dedicated to one or more specific QoE measurement configurations. The QoE configuration inquiry may specify one or more QoE configuration identities from a set of QoE configuration identities. Each of the set of QoE configuration identities represents parameters of QoE measurement configuration as described above, such as one or more service type, reporting type, reporting periodicity, whether the UE shall transmit indications when sessions in the application layer start and stop, whether segmentation of QoE reporting is allowed, and number of QoE reports over a period of time, or the like. The service type may be a service type of an application, for example, AR/VR, multicast/broadcast services and audio/video streaming, etc. The reporting type may include regular QoEs or RAN-visible QoEs, for example. At act 604, in some aspects, in response to the QoE configuration inquiry, the UE 101 may perform a UE reporting evaluation to determine whether a QoE measurement configuration is preferred or approved by the UE 101. In some aspects, the UE reporting evaluation at act 604 may be based on UE status. Status parameters of the UE 101 to determine the QoE reporting evaluation may include, for example, battery level of the UE 101, mobility level of the UE 101, or memory usage of the UE 101, buffer status of at least one radio bearer, channel quality, or application user setting (e.g. user privacy setting). For example, the UE 101 may disfavor QoE reporting, if the UE 101 has some conditions restricting reporting, such as a low battery, a high mobility, a high memory usage, a larger buffer size, a bad channel quality, a strict privacy setting, or any combination of the above. On the other hand, the UE 101 may allow QoE reporting, if one or multiple conditions are met such as none of the situations above exist.

At act 606, in some aspects, the UE 101 may send a configuration inquiry response to the BS 111 indicating QoE reporting preference or approval/disapproval. The configuration inquiry response may further comprise reasoning information indicating the reason why the UE 101 disfavors initiating, resuming or changing QoE reporting. For example, the reasoning information may include UE status information such as power level, mobility level, memory usage, buffer status of at least one radio bearer, channel quality, or application user setting. In some aspects, the configuration inquiry response may further comprise timing information related to a duration of time when the UE 101 will be available for the QoE measurement configuration, if the current response is disfavored or rejected. In some further aspects, the configuration inquiry response is dedicated to one or more specific QoE measurement configurations such as QoE configuration identities or service types. The QoE configuration identities represent QoE measurement configuration parameters such as reporting category (e.g., regular QoE, RAN-visible QoE, or both), periodicity, duration, etc. The service type may be a type of application, such as AR/VR, multicast/broadcast services and audio/video streaming, etc.

At act 608, in some aspects, the BS 111 may configure the UE 101 for QoE reporting based on the configuration inquiry response received from the UE 101. For example, if the configuration inquiry response favors QoE measurement configuration, the BS 111 may configure the QoE reporting based on the configuration inquiry response.

FIG. 7 is a schematic diagram illustrating signaling between a UE 101 and a BS 111 for QoE measurement reconfiguration based on UE evaluation in accordance with some additional aspects of the disclosure. At the time the BS 111 needs to resume or change QoE reporting from a QoE pause, instead of sending a resuming signal to the UE to resume QoE reporting directly, the BS 111 may firstly send a QoE configuration inquiry to the UE 101 to check whether the UE 101 prefers or capable of resuming or changing the QoE reporting. In one aspect, the schematic diagram may be understood as presented along a time line from top to bottom, but various acts could also happen in a different timing order. In some aspects, some or all features disclosed with reference to FIGS. 1-6 may be incorporated into or combined with features disclosed with reference to FIG. 7 when applicable. For example, acts 701-708 described below may be incorporated before or after the UE executes the QoE reconfiguration, such as pausing, resuming or changing QoE reporting as shown by act 212 associated with FIGS. 2-5. Alternatively, the acts 701-708 described below may be independent from aspects disclosed above associated with FIGS. 2-5.

For example, at act 702, the BS 111 may transmit QoE reporting inquiry to the UE 101 inquiring whether to resume or change QoE reporting. The QoE reporting inquiry may be transmitted prior to reconfiguring the QoE reporting. The reconfiguration of the UE reporting may be needed after a period of time or triggered by a certain condition after the QoE reporting is paused or changed at act 701. The QoE reporting inquiry may indicate a need to resume or change QoE reporting from perspective of the BS 111. In one aspect, the QoE reporting inquiry is dedicated to one or more specific QoE measurement configurations. The QoE reporting inquiry may specify one or more QoE configuration identities from a set of QoE configuration identities. Each of the set of QoE configuration identities represents parameters of QoE measurement configuration such as reporting category (e.g., regular QoE, RAN-visible QoE, or both), periodicity, duration, etc. The QoE reporting inquiry may alternatively or additionally specify a service type of the QoE reporting inquiry. The service type may be a service type of an application, for example, AR/VR, multicast/broadcast services and audio/video streaming, etc.

At act 704, in some aspects, in response to the QoE reporting inquiry, the UE 101 may perform a UE reporting evaluation to determine whether the QoE measurement reconfiguration is preferred or approved by the UE 101. In some aspects, the QoE reporting evaluation at act 704 may be based on UE status. Status parameters of the UE 101 to determine the QoE reporting evaluation may include, for example, battery level of the UE 101, mobility level of the UE 101, or memory usage of the UE 101, buffer status of at least one radio bearer, channel quality, or application user setting (e.g. user privacy setting). For example, the UE 101 may disfavor QoE reporting, if the UE 101 has some conditions restricting reporting, such as a low battery, a high mobility, a high memory usage, a larger buffer size, a bad channel quality, a strict privacy setting, or any combination of the above. On the other hand, the UE 101 may allow QoE reporting, if one or multiple conditions are met such as none of the situations above exist.

At act 706, in some aspects, the UE 101 may send a reporting inquiry response to the BS 111 indicating QoE reporting preference or approval/disapproval. The reporting inquiry response may further comprise reasoning information indicating the reason why the UE 101 disfavors initiating, resuming or changing QoE reporting. For example, the reasoning information may include UE status information such as power level, mobility level, memory usage, buffer status of at least one radio bearer, channel quality, or application user setting. In some aspects, the reporting inquiry response may further comprise information related to when the UE 101 will become available for initiating, resuming or changing, if the current response is disfavored. In some further aspects, the reporting inquiry response is dedicated to one or more specific QoE measurement configurations such as QoE configuration identities or service types. The QoE configuration identities represent QoE measurement configuration parameters as described above, one or more service type, reporting type, reporting periodicity, whether the UE shall transmit indications when sessions in the application layer start and stop, whether segmentation of QoE reporting is allowed, and number of QoE reports over a period of time, or the like. The service type may be a service type of an application, for example, AR/VR, multicast/broadcast services and audio/video streaming, etc. The reporting type may include regular QoEs or RAN-visible QoEs, for example.

At act 708, in some aspects, the BS 111 may reconfigure the UE 101 based on the reporting inquiry response received from the UE 101. For example, if the reporting inquiry response favors resuming or changing the QoE reporting, the BS 111 may instruct the UE 101 to resume or change the QoE reporting. The UE 101 then resume or change the QoE reporting based on the instruction from the BS 111.

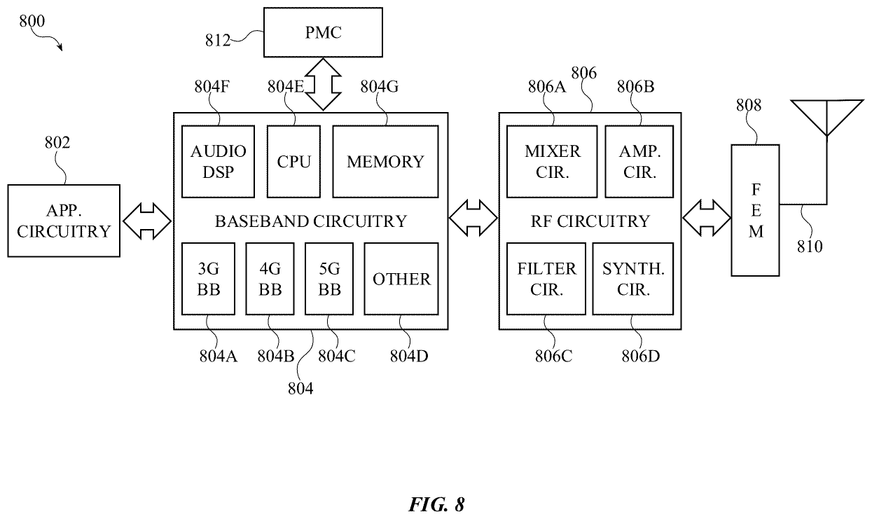

FIG. 8 is a diagram illustrating example components of a device 800 that can be employed in accordance with some aspects. In some aspects, the device 800 can include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 can be included in a UE or a RAN node such as the UE 101 or the BS 111 as described throughout this disclosure. In some implementations, the device 800 can include fewer elements (e.g., a RAN node may not utilize application circuitry 802 and instead include a processor/controller to process IP data received from a core network (CN), which may be a 5GC or an Evolved Packet Core (EPC)). In some implementations, the device 800 can include additional elements such as, for example, memory/storage, display, camera, sensor (including one or more temperature sensors, such as a single temperature sensor, a plurality of temperature sensors at different locations in device 800, etc.), or input/output (I/O) interface. In other implementations, the components described below can be included in more than one device (e.g., said circuitries can be separately included in more than one device for Cloud-RAN (C-RAN) implementations).

The application circuitry 802 can include one or more application processors. For example, the application circuitry 802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 800. In some implementations, processors of application circuitry 802 can process IP data packets received from an EPC.

The baseband circuitry 804 can include circuitry such as, but not limited to, one or more single-core or multi-core processors. The baseband circuitry 804 can include one or more baseband processors or control logic to process baseband signals received from a receive signal path of the RF circuitry 806 and to generate baseband signals for a transmit signal path of the RF circuitry 806. The baseband circuitry 804, or the one or more baseband processors or control logic of the baseband circuitry 804, may stand alone as the UE 101 or the BS 111 and perform signaling and operation in the meaning as described throughout this disclosure. The baseband circuitry 804 can interface with the application circuitry 802 for generation and processing of the baseband signals and for controlling operations of the RF circuitry 806. For example, in some implementations, the baseband circuitry 804 can include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), etc.). The baseband circuitry 804 (e.g., one or more of baseband processors 804A-D) can handle various radio control functions that enable communication with one or more radio networks via the RF circuitry 806. In other implementations, some or all of the functionality of baseband processors 804A-D can be included in modules stored in the memory 804G and executed via a Central Processing Unit (CPU) 804E. The radio control functions can include but are not limited to signal modulation/demodulation, encoding/decoding, radio frequency shifting, etc. In some implementations, modulation/demodulation circuitry of the baseband circuitry 804 can include Fast-Fourier Transform (FFT), precoding, or constellation mapping/demapping functionality. In some implementations, encoding/decoding circuitry of the baseband circuitry 804 can include convolution, tail-biting convolution, turbo, Viterbi, or Low Density Parity Check (LDPC) encoder/decoder functionality. Implementations of modulation/demodulation and encoder/decoder functionality are not limited to these examples and can include other suitable functionality in other implementations.

In some implementations, the baseband circuitry 804 can include one or more audio digital signal processor(s) (DSP) 804F. The audio DSP(s) 804F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 804 and the application circuitry 802 can be implemented together such as, for example, on a system on a chip (SOC).

In some implementations, the baseband circuitry 804 can provide for communication compatible with one or more radio technologies. For example, in some implementations, the baseband circuitry 804 can support communication with an NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 804 is configured to support radio communications of more than one wireless protocol can be referred to as multi-mode baseband circuitry.

RF circuitry 806 can enable communication with wireless networks using modulated electromagnetic radiation through a non-solid medium. In various implementations, the RF circuitry 806 can include switches, filters, amplifiers, etc., to facilitate communication with the wireless network. RF circuitry 806 can include a receive signal path which can include circuitry to down-convert RF signals received from the FEM circuitry 808 and provide baseband signals to the baseband circuitry 804. RF circuitry 806 can also include a transmit signal path which can include circuitry to up-convert baseband signals provided by the baseband circuitry 804 and provide RF output signals to the FEM circuitry 808 for transmission.

In some implementations, the receive signal path of the RF circuitry 806 can include mixer circuitry 806a, amplifier circuitry 806b, and filter circuitry 806c. In some implementations, the transmit signal path of the RF circuitry 806 can include filter circuitry 806c and mixer circuitry 806a. RF circuitry 806 can also include synthesizer circuitry 806d for synthesizing a frequency for use by the mixer circuitry 806a of the receive signal path and the transmit signal path. In some implementations, the mixer circuitry 806a of the receive signal path can be configured to down- convert RF signals received from the FEM circuitry 808 based on the synthesized frequency provided by synthesizer circuitry 806d. The amplifier circuitry 806b can be configured to amplify the down-converted signals, and the filter circuitry 806c can be a low-pass filter (LPF) or band-pass filter (BPF) configured to remove unwanted signals from the down-converted signals to generate output baseband signals. Output baseband signals can be provided to the baseband circuitry 804 for further processing. In some implementations, the output baseband signals can be zero-frequency baseband signals, although this is not a requirement. In some implementations, mixer circuitry 806a of the receive signal path can comprise passive mixers, although the scope of the implementations is not limited in this respect.

In some implementations, the mixer circuitry 806a of the transmit signal path can be configured to up-convert input baseband signals based on the synthesized frequency provided by the synthesizer circuitry 806d to generate RF output signals for the FEM circuitry 808. The baseband signals can be provided by the baseband circuitry 804 and can be filtered by filter circuitry 806c.

In some implementations, the mixer circuitry 806a of the receive signal path and the mixer circuitry 806a of the transmit signal path can include two or more mixers and can be arranged for quadrature downconversion and upconversion, respectively. In some implementations, the mixer circuitry 806a of the receive signal path and the mixer circuitry 806a of the transmit signal path can include two or more mixers and can be arranged for image rejection (e.g., Hartley image rejection). In some implementations, the mixer circuitry 806a of the receive signal path and the mixer circuitry 806a can be arranged for direct downconversion and direct upconversion, respectively. In some implementations, the mixer circuitry 806a of the receive signal path and the mixer circuitry 806a of the transmit signal path can be configured for super-heterodyne operation.

In some implementations, the output baseband signals and the input baseband signals can be analog baseband signals, although the scope of the implementations is not limited in this respect. In some alternate implementations, the output baseband signals and the input baseband signals can be digital baseband signals. In these alternate implementations, the RF circuitry 806 can include analog-to-digital converter (ADC) and digital-to-analog converter (DAC) circuitry, and the baseband circuitry 804 can include a digital baseband interface to communicate with the RF circuitry 806.

In some dual-mode implementations, a separate radio IC circuitry can be provided for processing signals for each spectrum, although the scope of the implementations is not limited in this respect.

In some implementations, the synthesizer circuitry 806d can be a fractional-N synthesizer or a fractional N/N+1 synthesizer, although the scope of the implementations is not limited in this respect as other types of frequency synthesizers can be suitable. For example, synthesizer circuitry 806d can be a delta-sigma synthesizer, a frequency multiplier, or a synthesizer comprising a phase-locked loop with a frequency divider.

The synthesizer circuitry 806d can be configured to synthesize an output frequency for use by the mixer circuitry 806a of the RF circuitry 806 based on a frequency input and a divider control input. In some implementations, the synthesizer circuitry 806d can be a fractional N/N+1 synthesizer.

FEM circuitry 808 can include a receive signal path which can include circuitry configured to operate on RF signals received from one or more antennas 810, amplify the received signals and provide the amplified versions of the received signals to the RF circuitry 806 for further processing. FEM circuitry 808 can also include a transmit signal path which can include circuitry configured to amplify signals for transmission provided by the RF circuitry 806 for transmission by one or more of the one or more antennas 810. In various implementations, the amplification through the transmit or receive signal paths can be done solely in the RF circuitry 806, solely in the FEM circuitry 808, or in both the RF circuitry 806 and the FEM circuitry 808.

In some implementations, the FEM circuitry 808 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 806). The transmit signal path of the FEM circuitry 808 can include a power amplifier (PA) to amplify input RF signals (e.g., provided by RF circuitry 806), and one or more filters to generate RF signals for subsequent transmission (e.g., by one or more of the one or more antennas 810).

In some implementations, the PMC 812 can manage power provided to the baseband circuitry 804. In particular, the PMC 812 can control power-source selection, voltage scaling, battery charging, or DC-to-DC conversion. The PMC 812 can often be included when the device 800 is capable of being powered by a battery, for example, when the device is included in a UE. The PMC 812 can increase the power conversion efficiency while providing desirable implementation size and heat dissipation characteristics.

While FIG. 8 shows the PMC 812 coupled only with the baseband circuitry 804. However, in other implementations, the PMC 812 may be additionally or alternatively coupled with, and perform similar power management operations for, other components such as, but not limited to, application circuitry 802, RF circuitry 806, or FEM circuitry 808.

In some implementations, the PMC 812 can control, or otherwise be part of, various power saving mechanisms of the device 800. For example, if the device 800 is in an RRC_Connected state, where it is still connected to the RAN node as it expects to receive traffic shortly, then it can enter a state known as Discontinuous Reception Mode (DRX) after a period of inactivity. During this state, the device 800 can power down for brief intervals of time and thus save power.

If there is no data traffic activity for an extended period of time, then the device 800 can transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 802 and processors of the baseband circuitry 804 can be used to execute elements of one or more instances of a protocol stack. For example, processors of the baseband circuitry 804, alone or in combination, can be used execute Layer 3, Layer 2, or Layer 1 functionality, while processors of the baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control (RRC) layer. As referred to herein, Layer 2 can comprise a medium access control (MAC) layer, a radio link control (RLC) layer, and a packet data convergence protocol (PDCP) layer. As referred to herein, Layer 1 can comprise a physical (PHY) layer of a UE/RAN node.

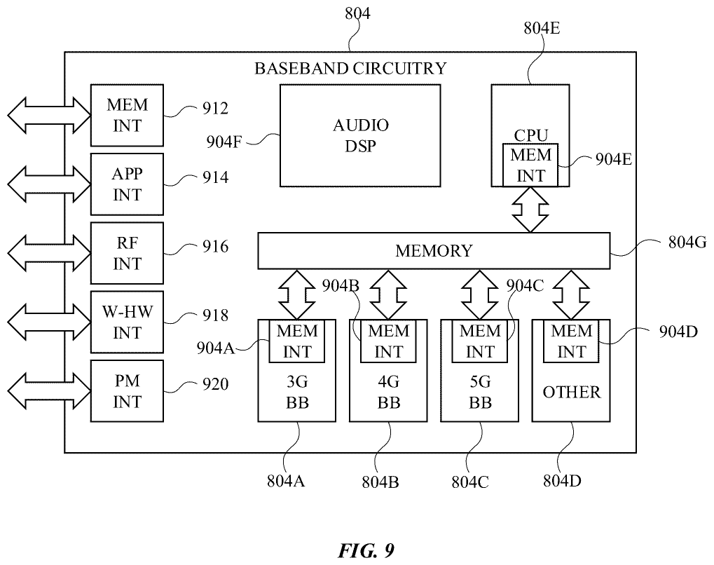

FIG. 9 illustrates a diagram illustrating example interfaces of baseband circuitry that can be employed in accordance with some aspects. As discussed above, the baseband circuitry 804 of FIG. 8 can comprise processors 804A-804E and a memory 804G utilized by said processors. Each of the processors 804A-804E can include a memory interface, 904A-904E, respectively, to send/receive data to/from the memory 804G.

The baseband circuitry 804 can further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is an apparatus of a user equipment (UE), the UE comprising one or more processors configured to transmit a Quality of Experience (QoE) reconfiguration or notification to a Base Station (BS) based on a UE reporting evaluation and pause, resume, suspend, or change QoE reporting to the BS based on the UE reporting evaluation.

Example 2 comprises the subject matter of any variation of any of example(s) 1, wherein the UE reporting evaluation is based on UE status parameters comprising at least one or more of battery level, mobility level, memory usage, buffer status of at least one radio bearer, channel quality, or application user setting.

Example 3 comprises the subject matter of any variation of any of example(s) 1, wherein the QoE reconfiguration request or notification further comprises a QoE measurement report.

Example 4 comprises the subject matter of any variation of any of example(s) 1, wherein the QoE reconfiguration request is transmitted by a UE Assistance Information (UAI) message.

Example 5 comprises the subject matter of any variation of any of example(s) 1, wherein the QoE reconfiguration request is transmitted by a MAC Control Element (MAC-CE).

Example 6 comprises the subject matter of any variation of any of example(s) 1, wherein the QoE reconfiguration request or notification further comprises QoE measurement configuration for idle or inactive state.

Example 7 comprises the subject matter of any variation of any of example(s) 1, wherein the QoE reconfiguration request or notification is dedicated to one or more QoE configuration identities from a set of QoE configuration identities, wherein each of the set of QoE configuration identities represents parameters of QoE measurement configuration.

Example 8 comprises the subject matter of any variation of any of example(s) 1, wherein the QoE reconfiguration request or notification further comprises reasoning information for the Quality of Experience (QoE) reconfiguration request or notification.

Example 9 comprises the subject matter of any variation of any of example(s) 1, prior to transmitting the QoE reconfiguration request or notification, the one or more processors further configured to receive network configuration to configure QoE reporting for the UE, and perform QoE measurements and report QoE measurement results to the BS based on the configured QoE reporting. The UE reporting evaluation is based on the QoE measurement results.

Example 10 comprises the subject matter of any variation of any of example(s) 1, wherein the QoE reconfiguration request or notification is a QoE reconfiguration request indicating preference of the UE on whether the QoE reporting should be paused, resumed, suspended, or changed.

Example 11 comprises the subject matter of any variation of any of example(s) 10, after transmitting the QoE reconfiguration request or notification, the one or more processors further configured to receive a reconfiguration request response from the BS, indicating rejection or approval of the QoE reconfiguration request. The QoE reporting to the BS is paused, resumed, suspended, or changed based on the reconfiguration request response.

Example 12 comprises the subject matter of any variation of any of example(s) 11, the one or more processors further configured to start a timer when transmitting the QoE reconfiguration request. The QoE reporting to the BS is paused, resumed, suspended, or changed if the UE does not receive the reconfiguration request response before the timer expires.

Example 13 comprises the subject matter of any variation of any of example(s) 1, wherein the QoE reconfiguration request or notification indicates parameters of QoE measurement reconfiguration including reconfiguration of a reporting periodicity, a reporting duration, or a number of QoE reports over a period of time.

Example 14 comprises the subject matter of any variation of any of example(s) 1, wherein the QoE reconfiguration request or notification is a UE notification indicating to the BS that the QoE reporting will be paused, resumed, suspended, or changed.

Example 15 is an apparatus of a baseband processor for a Base Station (BS), comprising one or more processors configured to receive a Quality of Experience (QoE) reconfiguration request or notification from a User Equipment (UE) based on a UE reporting evaluation, and transmit a request response or a notification confirmation to the UE in response to the QoE reconfiguration request or notification.

Example 16 comprises the subject matter of any variation of any of example(s) 15, wherein the QoE reconfiguration request or notification indicates a UE preference or capability to be reconfigured for QoE measurement reporting.

Example 17 comprises the subject matter of any variation of any of example(s) 15, wherein the QoE reconfiguration request or notification is transmitted by a UE Assistance Information (UAI) message.

Example 18 comprises the subject matter of any variation of any of example(s) 15, wherein the QoE reconfiguration request or notification further comprises QoE measurement configuration for idle or inactive state.

Example 19 comprises the subject matter of any variation of any of example(s) 15, wherein the QoE reconfiguration request or notification is dedicated to one or more QoE configuration identities from a set of QoE configuration identities, wherein each of the set of QoE configuration identities represents parameters of QoE measurement configuration.

Example 20 is a method for a User Equipment (UE) to trigger reconfiguration for Quality of Experience (QoE) measurement reporting. The method comprises performing a UE reporting evaluation for QoE measurement reconfiguration, transmitting a QoE reconfiguration request or notification to a Base Station (BS) based on the UE reporting evaluation, receive a request response or a notification confirmation from the BS, and pause, resume, suspend, or change QoE reporting to the BS based on the request response or the notification confirmation.

Example 21 is an apparatus of a user equipment (UE), the UE comprising one or more processors configured to receive a Quality of Experience (QoE) configuration inquiry from a Base Station (BS) inquiring whether to perform a QoE measurement configuration, and transmit a configuration inquiry response indicating a rejection or an approval of the QoE measurement configuration.

Example 22 comprises the subject matter of any variation of any of example(s) 21, wherein the one or more processors are further configured to after receiving the QoE configuration inquiry, perform a UE reporting evaluation for the QoE measurement configuration. The UE reporting evaluation is based on UE status parameters comprising at least one or more of battery level, mobility level, memory usage, buffer status of at least one radio bearer, channel quality, or application user setting.

Example 23 comprises the subject matter of any variation of any of example(s) 21, wherein the one or more processors are further configured to receive the QoE measurement configuration if the configuration inquiry response indicates the approval of the QoE measurement configuration.

Example 24 comprises the subject matter of any variation of any of example(s) 21, wherein the QoE configuration inquiry is dedicated to one or more QoE configuration identities from a set of QoE configuration identities, wherein each of the set of QoE configuration identities represents parameters of the QoE measurement configuration.

Example 25 comprises the subject matter of any variation of any of example(s) 21, the QoE configuration inquiry is dedicated to one or more service types.

Example 26 comprises the subject matter of any variation of any of example(s) 21, wherein the configuration inquiry response comprises reasoning information if the QoE configuration inquiry is rejected by the UE, indicating a reason for the rejection of the QoE configuration inquiry.

Example 27 comprises the subject matter of any variation of any of example(s) 21, wherein the configuration inquiry response comprises timing information if the configuration inquiry response indicates the rejection of the QoE measurement configuration, indicating a duration of time when the UE will be available for the QoE measurement configuration.

Example 28 is an apparatus for a Base Station (BS), comprising one or more processors configured to transmit a Quality of Experience (QoE) reporting inquiry to a User Equipment (UE) inquiring whether to resume or change QoE reporting, receive a reporting inquiry response from the UE, indicating rejection or approval of the QoE reporting inquiry, and configure the UE to resume or change QoE reporting based on the reporting inquiry response.

Example 29 comprises the subject matter of any variation of any of example(s) 28, wherein the QoE reporting inquiry is dedicated to one or more QoE configuration identities from a set of QoE configuration identities, wherein each of the set of QoE configuration identities represents parameters of QoE measurement configuration.

Example 30 comprises the subject matter of any variation of any of example(s) 28, wherein the QoE reporting inquiry is dedicated to one or more service types.

Example 31 comprises the subject matter of any variation of any of example(s) 28, wherein the reporting inquiry response comprises reasoning information if the QoE reporting inquiry is rejected by the UE, indicating a reason for the rejection of the QoE reporting inquiry.

Example 32 comprises the subject matter of any variation of any of example(s) 28, wherein the reporting inquiry response comprises timing information if the QoE reporting inquiry is rejected by the UE, indicating a duration of time when the UE will be available for the resuming or changing of the QoE reporting.

Example 33 is an apparatus apparatus for a User Equipment (UE), comprising one or more processors configured to receive a Quality of Experience (QoE) reporting inquiry from a Base Station (BS), inquiring whether to resume or change QoE reporting, transmit a reporting inquiry response indicating rejection or approval of the QoE reporting inquiry, and resume or change QoE reporting based on the reporting inquiry response.

Example 34 comprises the subject matter of any variation of any of example(s) 33, wherein the reporting inquiry response is dedicated to one or more QoE configuration identities from a set of QoE configuration identities, wherein each of the set of QoE configuration identities represents parameters of QoE measurement configuration.

Example 35 comprises the subject matter of any variation of any of example(s) 33, wherein the reporting inquiry response is dedicated to one or more service types.

Example 36 comprises the subject matter of any variation of any of example(s) 33, wherein the reporting inquiry response comprises reasoning information if the QoE reporting inquiry is rejected by the UE, indicating a reason for the rejection of the QoE reporting inquiry.

Example 37 comprises the subject matter of any variation of any of example(s) 33, wherein the reporting inquiry response comprises timing information if the QoE reporting inquiry is rejected by the UE, indicating a duration of time when the UE will be available for the resuming or changing of the QoE reporting.

Example 38 comprises the subject matter of any variation of any of example(s) 33, after transmitting the reporting inquiry response, the one or more processors further configured to receive QoE measurement reconfiguration from the BS based on the reporting inquiry response to configure the resuming or changing of the QoE reporting.

Example 39 comprises the subject matter of any variation of any of example(s) 33, wherein the QoE reporting inquiry is dedicated to one or more QoE configuration identities from a set of QoE configuration identities, wherein each of the set of QoE configuration identities represents parameters of QoE measurement configuration.

Example 40 comprises the subject matter of any variation of any of example(s) 33, wherein the QoE reporting inquiry is dedicated to one or more service types.

Example 41 is a method that includes any action or combination of actions as substantially described herein in the Detailed Description.

Example 42 is a method as substantially described herein with reference to each or any combination of the Figures included herein or with reference to each or any combination of paragraphs in the Detailed Description.

Example 43 is a user equipment configured to perform any action or combination of actions as substantially described herein in the Detailed Description as included in the user equipment.

Example 44 is a network node configured to perform any action or combination of actions as substantially described herein in the Detailed Description as included in the network node.

Example 45 is a non-volatile computer-readable medium that stores instructions that, when executed, cause the performance of any action or combination of actions as substantially described herein in the Detailed Description.

Example 46 is a baseband processor of a user equipment configured to perform any action or combination of actions as substantially described herein in the Detailed Description as included in the user equipment.

Example 47 is a baseband processor of a network node configured to perform any action or combination of actions as substantially described herein in the Detailed Description as included in the user equipment.

Example 48 includes a product comprising one or more tangible computer-readable non-transitory storage media comprising computer-executable instructions operable to, when executed by at least one computer processor, enable the at least one processor to perform the method of any one of the Examples above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An apparatus comprising memory coupled to a baseband processor, the baseband processor configured to:
generate a Quality of Experience (QoE) reconfiguration request or notification for transmission to a Base Station (BS) based on a User Equipment (UE) reporting evaluation; and
pause, resume, suspend, or change QoE reporting to the BS based on the UE reporting evaluation.

2. The apparatus of claim 1, wherein the UE reporting evaluation is based on UE status parameters comprising at least one or more of battery level, mobility level, memory usage, buffer status of at least one radio bearer, channel quality, or application user setting.

3. The apparatus of claim 1, wherein the QoE reconfiguration request or notification further comprises a QoE measurement report.

4. The apparatus of claim 1, wherein the QoE reconfiguration request is transmitted by a UE Assistance Information (UAI) message.

5. The apparatus of claim 1, wherein the QoE reconfiguration request is transmitted by a MAC Control Element (MAC-CE).

6. The apparatus of claim 1, wherein the QoE reconfiguration request or notification further comprises QoE measurement configuration for idle or inactive state.

7. The apparatus of claim 1, wherein the QoE reconfiguration request or notification is dedicated to one or more QoE configuration identities from a set of QoE configuration identities, wherein each of the set of QoE configuration identities represents parameters of QoE measurement configuration.

8. The apparatus of claim 1, wherein the QoE reconfiguration request or notification further comprises reasoning information for the Quality of Experience (QoE) reconfiguration request or notification.

9. The apparatus of claim 1, prior to transmitting the QoE reconfiguration request or notification, the one or more processors further configured to:
receive network configuration to configure QoE reporting for the UE; and
perform QoE measurements and report QoE measurement results to the BS based on the configured QoE reporting,
wherein the UE reporting evaluation is based on the QoE measurement results.

10. The apparatus of claim 1, wherein the QoE reconfiguration request or notification is a QoE reconfiguration request indicating preference of the UE on whether the QoE reporting should be paused, resumed, suspended, or changed.

11. The apparatus of claim 10, after transmitting the QoE reconfiguration request or notification, the one or more processors further configured to:
receive a reconfiguration request response from the BS, indicating rejection or approval of the QoE reconfiguration request,
wherein the QoE reporting to the BS is paused, resumed, suspended, or changed based on the reconfiguration request response.

12. The apparatus of claim 11, the one or more processors further configured to:
start a timer when transmitting the QoE reconfiguration request,
wherein the QoE reporting to the BS is paused, resumed, suspended, or changed if the UE does not receive the reconfiguration request response before the timer expires.

13. The apparatus of claim 1, wherein the QoE reconfiguration request or notification indicates parameters of QoE measurement reconfiguration including reconfiguration of a reporting periodicity, a reporting duration, or a number of QoE reports over a period of time.

14. The apparatus of claim 1, wherein the QoE reconfiguration request or notification is a UE notification indicating to the BS that the QoE reporting will be paused, resumed, suspended, or changed.

15. An apparatus comprising memory coupled to a baseband processor, the baseband processor configured to:
receive a Quality of Experience (QoE) reconfiguration request or notification on a User Equipment (UE) reporting evaluation; and
generate a request response or a notification confirmation for transmission to the UE in response to the QoE reconfiguration request or notification.

16. The apparatus of claim 15, wherein the QoE reconfiguration request or notification indicates a UE preference or capability to be reconfigured for QoE measurement reporting.

17. The apparatus of claim 15, wherein the QoE reconfiguration request or notification is transmitted by a UE Assistance Information (UAI) message.

18. The apparatus of claim 15, wherein the QoE reconfiguration request or notification further comprises QoE measurement configuration for idle or inactive state.

19. The apparatus of claim 15, wherein the QoE reconfiguration request or notification is dedicated to one or more QoE configuration identities from a set of QoE configuration identities, wherein each of the set of QoE configuration identities represents parameters of QoE measurement configuration.

20. A method for a User Equipment (UE) to trigger reconfiguration for Quality of Experience (QoE) measurement reporting, the method comprising:
performing a UE reporting evaluation for QoE measurement reconfiguration;
transmitting a QoE reconfiguration request or notification to a Base Station (BS) based on the UE reporting evaluation;
receiving a request response or a notification confirmation from the BS; and
pausing, resuming, suspending, or changing QoE reporting to the BS based on the request response or the notification confirmation.

21-40. (canceled)
